(19) United States
(12) Patent Application Publication
(10) Pub. No.: US 2018/0345223 A1
(43) Pub. Date: Dec. 6, 2018

(54) MULTI-STAGE FILTRATION SYSTEM FOR HETEROGENEOUS FOOD MIXTURES

(71) Applicant: VELO ACCIAI S.R.L., San Zenone Degli Ezzelini (IT)

(72) Inventors: Giovanni Velo, San Zenone Degli Ezzelini (IT); Mazzocato Luigi, Montebelluna (IT)

(73) Assignee: VELO ACCIAI S.R.L., San Zenone Degli Ezzelini (IT)

(21) Appl. No.: 15/821,495

(22) Filed: Nov. 22, 2017

(30) Foreign Application Priority Data
Nov. 24, 2016 (IT) 202016000119259

(51) Int. Cl. B01D 63/06; B01D 61/18; B01D 61/22; B01D 61/16; B01D 69/02; C12G 1/08; C12H 1/07

(52) U.S. Cl. CPC B01D 63/06; B01D 2325/02; B01D 61/22; B01D 61/16; B01D 69/02; C12G 1/08; C12H 1/063; B01D 2311/04; B01D 2311/08; B01D 2311/25; B01D 2311/2649; B01D 2313/50; B01D 2315/10; B01D 2317/04; B01D 2317/08; B01D 61/18

(57) ABSTRACT

A multi-stage filtration system for heterogeneous food mixtures. The system comprises a tank for holding the heterogeneous mixture to be filtered. First and second filtering devices receive heterogeneous mixtures from the tank and divide them into a first (second) portion of mixture and a residual (second residual) portion of solid mixture. First and second feeding conduits and first and second connecting conduits between the tank and the first and second filtering devices feed the heterogeneous mixtures to the first and second filtering devices and the first and second portions of mixture to the tank, respectively. The first and the second filtering devices comprise tangential filtration filtering units comprising first filtering members of the membrane type, and second filtering members of the tubular type, respectively.

### RELATED APPLICATION

The present invention claims the benefit of priority to Italian Patent Application No. 202016000119259 titled “MULTI-STAGE FILTRATION SYSTEM FOR HETEROGENEOUS FOOD MIXTURES,” filed on behalf of the inventors and assigned to the assignee of the present application and incorporated in this application by reference in its entirety.

### TECHNICAL FIELD

The present invention relates to a multi-stage filtration system and a filtration method for filtering heterogeneous food mixtures.

### TECHNOLOGICAL BACKGROUND

In the field of the filtration of liquids with solid contents dispersed therein, which are herein below referred to as heterogeneous food mixtures for the sake of brevity, and particularly in the oenology field, it is a fundamental and strategic requirement of filtering and purifying mixtures and solutions having different corpuscular content percentages in reduced times and obtaining high end purity values. In such a field, the use of filtering members for filtering food liquids in order to remove parts of the solid residues dispersed therein is known.

Tangential filtration filtering members are usually used.

Such a technology is particularly versatile for selectively separating the desired dimensions of a suspended solid. In particular, in the field of the treatment of wines, it is necessary to filter and purify a determined mixture from undesired particles, solid contaminants, and microorganisms, while keeping the protein and colloidal structure of the wine itself unaltered. Also, it is fundamental in all the processes for treating oenological suspensions, to control, and possibly decrease, the working temperature of these mixtures, since excessive fluctuations of the temperature could lead to variations and/or adulterations in the organoleptic components contained in the mixtures.

However, such sophisticated filtration and purification technology has the inherent limitation that it is more efficient as the dimensions of the corpuscular components approximate more the dimensions which are ideal for the interaction with the holes of the membrane contained in the tangential filtration system and the amounts of suspended solid material do not exceed preset values.

As a result, among the most significant challenges relating to the industrial use of this technology, there are frequent blockages of the filters, which involve a decrease in the performance of the tangential filters and a resulting lengthening of the process times, due to the several stoppages of the filtering processes, dedicated to the cleaning and filter restoration steps.

A further drawback is the undesired increase of the temperature of the suspension during the filtration, which results in the risk of changing the properties and the organoleptic characteristics of the mixture.

In order to optimize the filtration of the wine, the use of a first filtering apparatus is provided, comprising a filter for filtering particles of larger dimensions, at the outlet of which a filtered wine and a paste-like residue are obtained. The latter is treated in a further filtering apparatus so as to remove the smaller particles and to obtain a further residue and a further oenologic product.

A shortcoming of such a system is that two distinct filtered products are obtained, having organoleptic characteristics that are different one from the other.

Such products have to be targeted to different markets, and have a different commercial value.

In particular, the wine that is filtered by the one of the two filtering apparatuses contains an amount of residues therein that is too high, and this compromises the organoleptic characteristics and the duration thereof, on the contrary, it is at the same time the risk that the wine that is filtered at the exit of the other filtering apparatus is too pure, thus lacking in substances which may characterize its flavor.

In both cases, the obtained products might not have optimal organoleptic characteristics.

Therefore, an object of the invention is to provide a multi-stage filtration system for heterogeneous food mixtures that solves the drawbacks mentioned above with reference to the cited prior art.

In particular, an object of the invention is to provide a filtration system that allows efficiently treating large amounts of heterogeneous mixtures having variable and also significant percentages of solid suspensions, while maintaining the advantages of the high selectivity which can be obtained by the tangential filter systems.

Another object is to provide a filtering apparatus in which the expected stops for the maintenance and reactivation of the filters are reduced compared to the known systems.

### SUMMARY OF THE INVENTION

According to a first aspect of the invention, a multi-stage filtration system for heterogeneous food mixtures is provided, comprising a tank for holding the heterogeneous mixture to be filtered, a first filtering device intended to receive the heterogeneous mixture from the tank and to divide it into a first portion of mixture and a residual portion of solid mixture, a first feeding conduit and a first connecting conduit between the tank and the first filtering device, in order to feed the heterogeneous mixture to the first filtering device and the first portion of mixture to the tank, respectively, a second filtering device intended to receive a concentrated heterogeneous mixture from the tank and to divide it into a second portion of mixture and a second residual portion of solid mixture, a second feeding conduit and a second connecting conduit between the tank and the second filtering device, in order to feed the concentrated heterogeneous mixture to the second filtering device and the second portion of mixture to the tank, respectively, wherein the first and the second filtering devices comprise tangential filtration filtering units comprising first filtering members of the membrane type and second filtering members of the tubular type, respectively.

The presence of two distinct filtering units in the same apparatus allows the filtration process to be optimized.

Furthermore, the presence of two distinct filtering units allows obtaining an end product having good organoleptic characteristics and which is pure.

The use of two filtering units using tangential filtration filters allows making the apparatus according to the invention efficient.

The process is optimized by reducing the amount of waste product, while increasing the quality of the end product obtained.

The use of two filtering units which use tangential filtration filters that are different one from the other, i.e., a membrane-type filter and a tubular-type filter, allows efficient removal of both particles having a large particle size and particles having more reduced sizes from the heterogeneous mixture being treated.

Therefore, the quality of the end product obtained is considerably improved.

Also the working times between two subsequent stops for cleaning the filters are increased.

In a version, the multi-stage filtration system further comprises a prefiltration filtering device operatively interposed between the first filtering device and the tank and intended to receive the heterogeneous mixture from the tank and to carry out a prefiltration of the heterogeneous mixture. Further advantageous aspects of the invention are described in the preferred embodiments which are described below. It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawings are the following figures:

FIG. 1 is a simplified scheme of one embodiment or version of the apparatus according to the invention;

FIG. 2 is a schematic perspective view of a filtering unit of the apparatus according to the invention;

FIGS. 2A-2B are enlarged views of the details A and B of FIG. 2, respectively;

FIG. 3 is a sectional view of a tank of the apparatus of FIG. 1;

FIG. 4 is a simplified scheme of a further version of the apparatus according to the invention;

FIG. 5 is a schematic perspective view of the filtering unit of the apparatus of FIG. 4; and

FIG. 6 is a schematic sectional view of a prefilter of the apparatus of FIG. 5.

### PREFERRED EMBODIMENTS OF THE INVENTION

In the Figures, a multi-stage filtration apparatus 100, 100′ for heterogeneous food mixtures manufactured in accordance with embodiments of the present invention is shown.

The apparatus 100, 100′ is particularly arranged to filter food mixtures relating to the oenological production system; however, it will be easily used for or easily adjusted by one skilled in the art to be used in a treatment process for different types of mixtures (for example, fruit juices, etc.).

The apparatus 100, 100′ is particularly suitable to treat heterogeneous food mixtures, i.e., heterogeneous mixtures having contents of solids dispersed therein.

The apparatus 100, 100′ is particularly suitable to treat heterogeneous food mixtures having a variable percentage of solid content therein, ranging up to 40% based on the ratio of the solid volumes and the total volume of the heterogeneous mixture.

Preferably, the apparatus 100, 100′ is suitable to treat heterogeneous mixtures having a percentage of solids ranging between 0.1 and 10% based on the ratio of the solid volumes in the total volume of the heterogeneous mixture. The percentages above refer to the percentage of the solid volumes in the total volume of the heterogeneous mixture.

Most preferably, the apparatus 100, 100′ is suitable to efficiently treat mixtures having a content of solids dispersed therein which ranges between 5-40%, most preferably between 7-10% of the total volume of the heterogeneous mixture.

The apparatus 100, 100′ is particularly adapted to treat wine lees, must lees, wine, etc.

The apparatus 100, 100′ is particularly suitable to treat mixtures containing also gases, as sparkling wines.

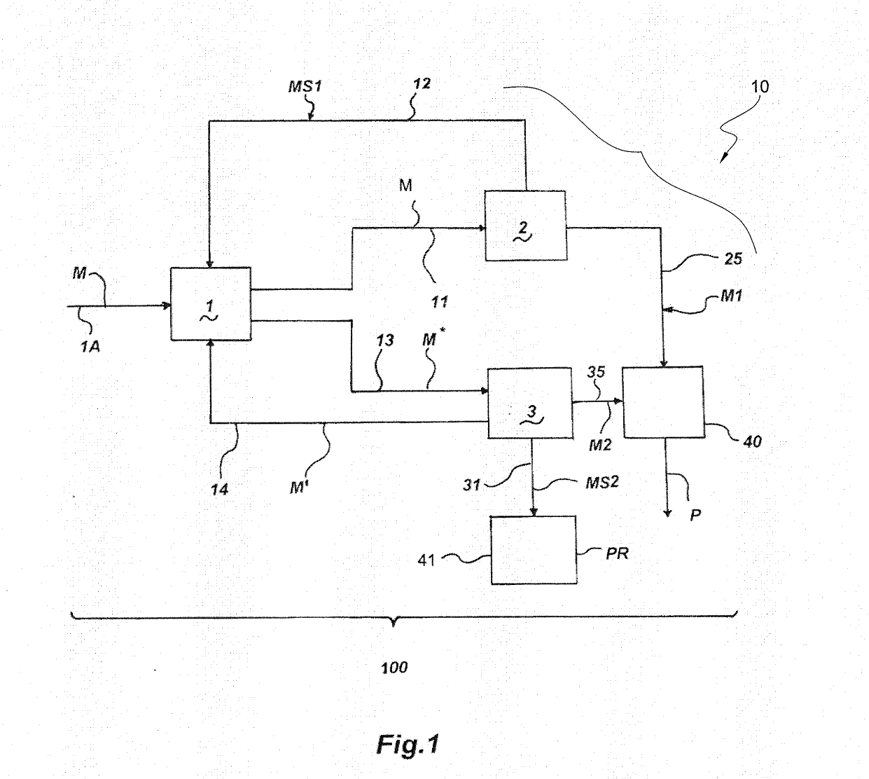

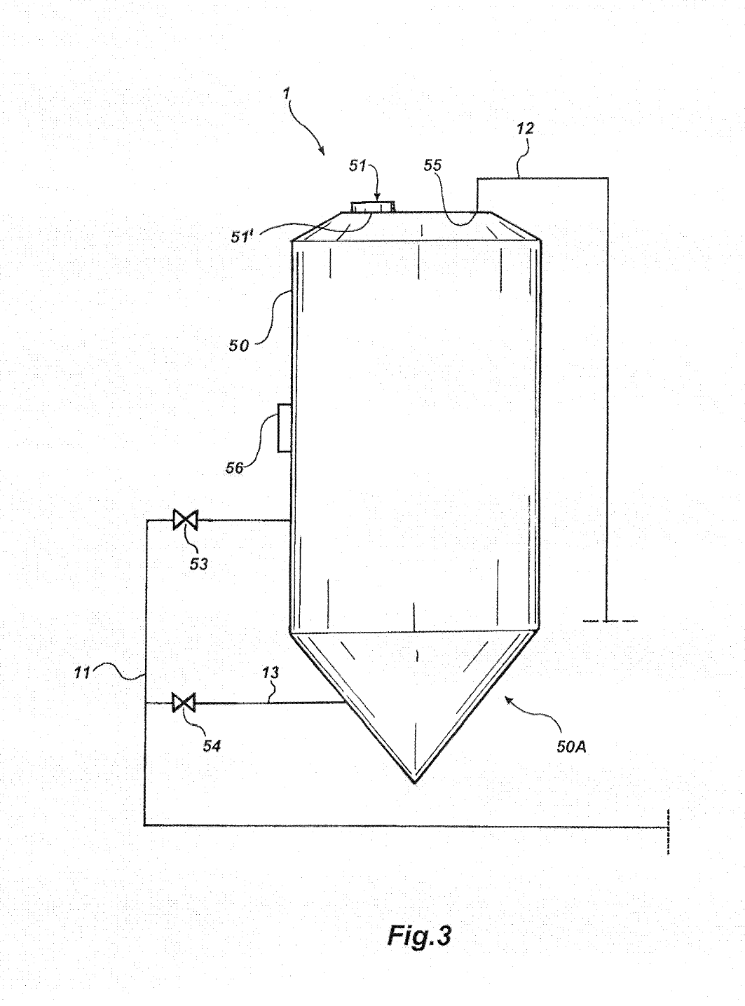

Referring now to the drawings, in which like reference numbers refer to like elements throughout the various figures that comprise the drawings, and with particular reference to FIGS. 1-3, the apparatus 100 comprises a filtering unit 10 arranged so as to divide the heterogeneous mixture M in an end product P having high organoleptic properties and in a waste residual product PR.

Furthermore, the apparatus 100 comprises a feeding device 1A to feed the heterogeneous mixture M to the filtering unit 10.

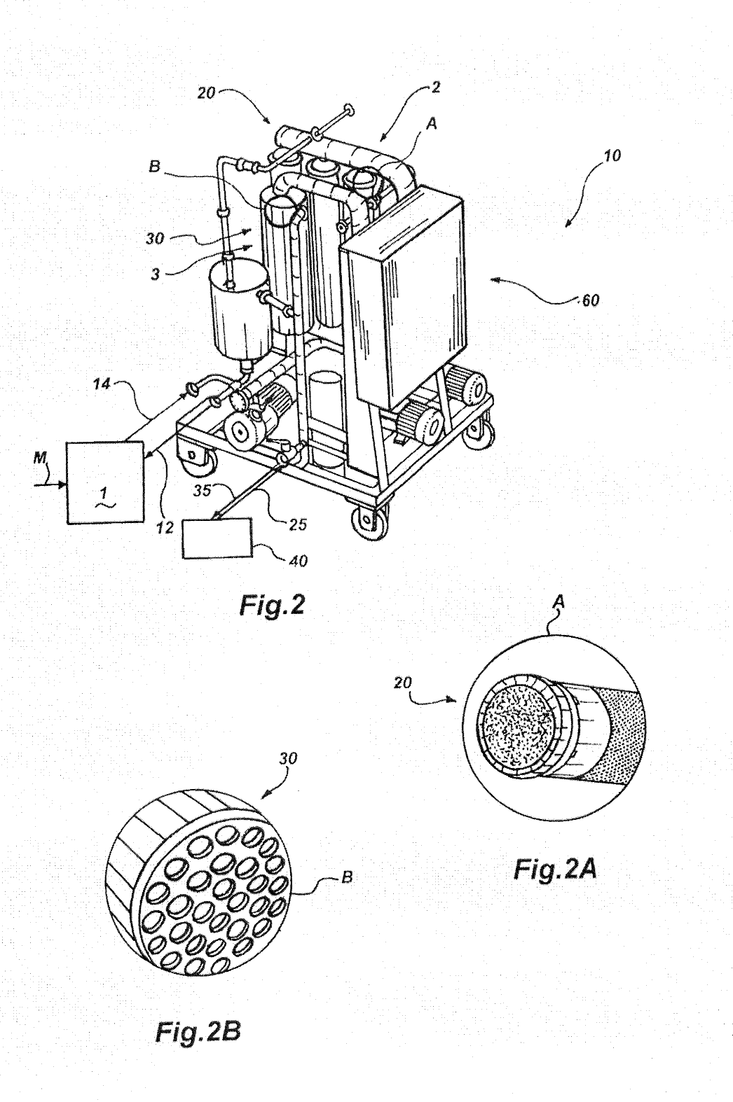

The filtering unit 10, shown in more detail in FIG. 2, comprises a tank 1 intended to receive the heterogeneous mixture M to be filtered via the feeding device 1A and suitable to contain the heterogeneous mixture M to be filtered, a first filtering device 2 operatively connected to the tank 1 via a first feeding conduit 11 arranged so as to feed the heterogeneous mixture M to be filtered from the tank 1 to the first filtering device 2.

The first filtering device 2 is intended to receive the heterogeneous mixture M from the tank 1 and to divide it into a first portion of filtered mixture Ml and a residual portion of solid mixture MS1.

The first portion of filtered mixture M1 is transported via a connecting pipe 25 to a collection tank 40.

The residual portion of solid mixture MS1 is transported, via a first connecting conduit 12, to the tank 1 in order to be filtered again, as better explained herein below. The first filtering device 2 comprises a first plurality of first filtering members 20, shown in more detail in FIG. 2A and explained in more detail below, intended to filter the heterogeneous mixture M.

Furthermore, the filtering unit 10 comprises a second filtering device 3 operatively connected to the tank 1 via a second feeding conduit 13 to feed a mixture to be filtered from the tank 1 to the second filtering device 3.

The second filtering device 3 is intended to receive a concentrated heterogeneous mixture M* from the tank 1 and to divide it into a second portion of filtered mixture M2 and a second residual portion of solid mixture MS2.

The second portion of filtered mixture M2 is transported via a second connecting pipe 35 to the collection tank 40.

The second residual portion of solid mixture MS2 is transported via a discharge conduit 31 into a container 41.

Furthermore, the filtering unit 10 comprises a recirculation conduit 14 to feed a concentrated filtered mixture M′ from the second filtering device 3 to the tank 1.

In such a manner, the concentrated heterogeneous mixture M* in the tank 1 can be subjected to several filtration cycles in the second filtering device 3, as better explained herein below.

The second filtering device 3 comprises a plurality of second filtering members 30, shown in more detail in FIG. 2B and better explained below, intended to filter the concentrated heterogeneous mixture M*.

Advantageously, both the first 2 and the second filtering device 3 comprise respective filtering members 20, 30 of the tangential filtration type.

In a preferred version, the first filtering members 20 are of the membrane type and can be made of ceramic, or plastic, or polyethersulfone.

In another version the first and the second filtering members 20, 30 can be of the membrane spiral type, preferably wound around the longitudinal axis of the filtering members 20, 30.

In a preferred version, the first filtering members 20 are of the capillary membrane type. The first filtering members 20 are capillary filtering members having an inner diameter ranging between 1-2 mm.

The first filtering members 20 are advantageously composed of membranes having a porosity ranging between 0.1 and 0.8 microns.

The first filtering members 20 are advantageously filtering members that are suitable to filter liquids having a low solid content in inflow, preferably heterogeneous mixtures having a percentage of solids ranging between 0.2 and 10% based on the overall volume of the mixture to be filtered, preferably between 7-10%.

In a preferred version, the second filtering members 30 are of the tubular membrane type. Advantageously, the second filtering members 30 are made of steel, or a resistant ceramic, or polymeric material.

Advantageously, the membranes of the second filtering members 30 are tubular with filtration channels, in which the concentrated heterogeneous mixture M* to be filtered flows, having a diameter ranging between 5-20 mm.

The second filtering members 30 are advantageously composed of membranes having a porosity ranging between 0.1 and 0.8 microns.

The second filtering members 30 are advantageously filtering members that are suitable to filter liquids having a high solid content in inflow, preferably heterogeneous mixtures having a percentage of solids ranging between 0.2 and 50% based on the overall volume of the mixture to be filtered, preferably between 20-50%.

The tank 1 comprises a containing body 50 having an almost cylindrical shape, with a cone-shaped lower portion 50A, made of steel or other material that is suitable to hold heterogeneous food mixtures.

The tank 1 is provided with a feeding mouth 51 connected to the feeding device 1 A and intended to allow the inlet of the heterogeneous mixture M to be treated within the containing body 50 and ending with a first inlet valve 51′ which is actuatable to allow/prevent the inlet of mixture in the containing body 50.

Advantageously, the feeding mouth 51 is located in a portion of the containing body 50, so that the mixture to be filtered is dispersed via gravity within the containing body 50.

The tank 1 is also provided with a first feeding valve 53 on which the first feeding conduit 11 is engaged, and intended to be opened/closed to allow the discharge of the heterogeneous mixture M towards the first filtering device 2.

The tank 1 is also provided with a second feeding valve 54 on which the second feeding conduit 13 is engaged to feed the concentrated heterogeneous mixture M* from the tank 1 to the second filtering device 3.

The second feeding valve 54 is intended to be opened/closed to allow the discharge of the concentrated heterogeneous mixture M* towards the second filtering device 3.

Advantageously, the first feeding valve 53 is located at a greater height in the tank 1 with respect to the second feeding valve 54.

Furthermore, the tank 1 comprises a second inlet valve 55 on which the first connecting conduit 12 is engaged to allow the inlet of the residual portion of solid mixture MS1 from the first filtering device 2 in the tank 1.

Advantageously, the second inlet valve 55 is located in an upper portion of the tank 1.

Furthermore, the tank 1 comprises a third inlet valve, not shown in the Figures, on which the recirculation conduit 14 is engaged to allow the inlet of the concentrated filtered mixture M′ from the second filtering device 3 to the tank 1.

Advantageously, the tank 1 is provided with at least one level sensor 56 arranged so as to measure the level of the heterogeneous mixture M within the tank 1. Preferably, a plurality of level sensors 56 located at different levels of the tank 1 is provided for.

The apparatus 100 comprises, in some versions, pressure and/or flow rate sensors, arranged on the feeding conduits 11, 13, and/or the connecting conduits 12, 14 or the pipes, and arranged so as to detect the pressure and/or flow rate.

Furthermore, the filtration apparatus 100 comprises a feeding device, not shown in the Figures, for example, a pump, so as to circulate the mixtures within the apparatus itself. Furthermore, the filtration apparatus 100 comprises a control unit 60 to control and adjust the operation of the filtration apparatus 100 itself. The control unit 60 is operatively connected to the first and the second feeding valves 53, 54 and to the first and the second inlet valves 51′, 55 to control the opening/closure thereof.

The control unit 60 is also connected to the level sensor 56 or the level sensors 56 so as to receive the measurement of the level of heterogeneous mixture M in the tank 1.

The control unit 60 is also operatively connected to the pressure or flow rate sensors that are possibly present in the apparatus 100 to receive the measurements of the corresponding parameters.

The control unit 60 is also operatively connected to the first and the second filtering devices 2, 3, to receive information on the operation thereof, and to control the operation, activation/stop thereof, for example.

The filters of the first filtering members 20 and/or the second filtering members 30 are, as stated, tangential filtration filters of the membrane type.

The type of membrane is selected based on the mixture to be treated and the percentage of solids present therein.

The tangential filters are arranged in a substantially perpendicular manner to the longitudinal axis of the filtering devices 2, 3.

Ceramic membranes, or steel membranes could be advantageously used.

Additionally, spiral membrane filters could be used, preferably the spiral being wound around the longitudinal axis of the filtering members.

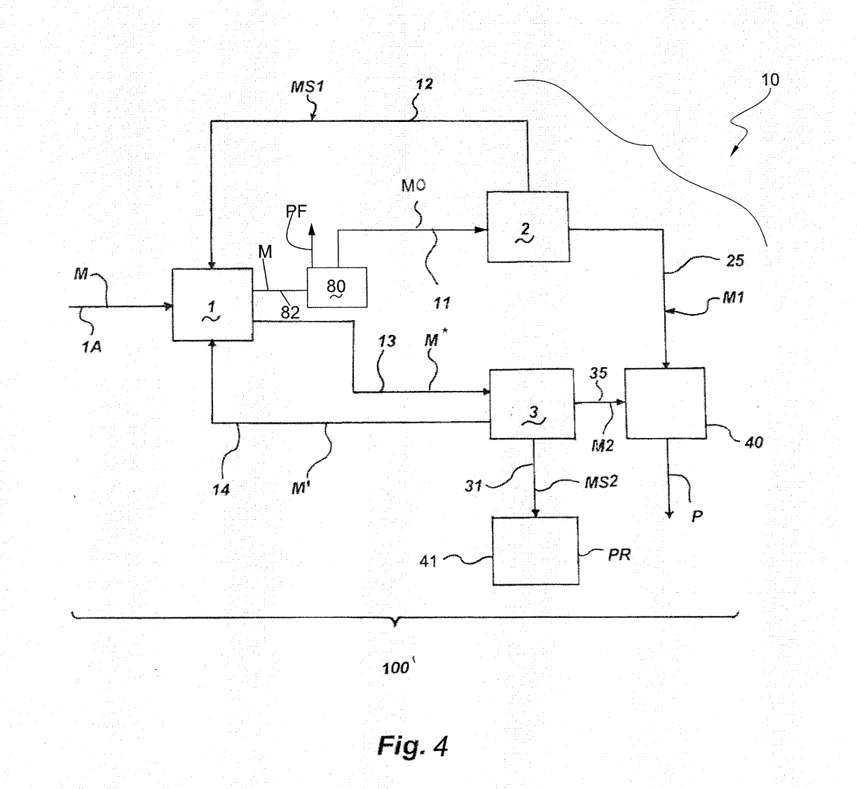

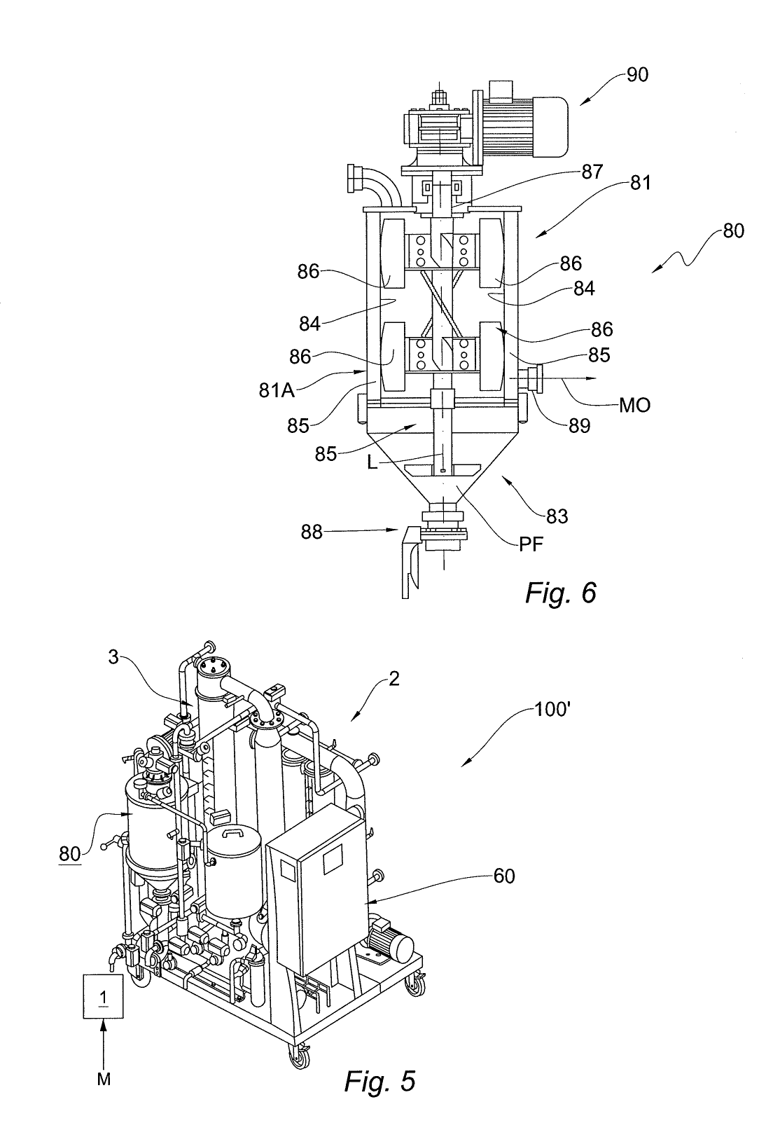

In FIGS. 4 and 5 a further version of the filtration apparatus 100′ of the invention it is shown. Parts corresponding to the parts of version of the apparatus 100 disclosed above are indicated with the same reference numbers and will not be described in the following.

In the version of the apparatus shown in FIGS. 4 and 5, the filtration apparatus 100′ further comprises a prefiltration filter 80 operatively interposed between the first filtering device 2 and the tank 1 and intended to receive the heterogeneous mixture M from the tank 1 in order to carry out a prefiltration of the heterogeneous mixture M.

The prefiltration filter 80, best shown in FIG. 6, comprises a prefiltration containing body 81 intended to receive the heterogeneous mixture M from the tank 1 by means of a prefiltration conduit 82.

The prefiltration containing body 81 is preferably almost cylindrical, with a cone-shaped lower portion 83.

The prefiltration containing body 81 is preferably made of steel, or other material that is suitable to hold heterogeneous food mixtures.

Inside the prefiltration containing body 81 is provided a prefiltering wall 84 defining a prefiltering chamber.

The prefiltering wall 84 is so positioned that a gap 85 it is defined between the outer wall 81A of the prefiltration containing body 81 and the prefiltering wall 84.

The prefiltering wall 84 is pierced, i.e., provided with hole for allowing the passage of material therethrough, as will be better explained in the following.

The dimension of the holes of the prefiltering wall 84 is chosen in dependence on the features of the heterogeneous mixture M and the solid content thereof, preferably the diameter of the holes is between 0.5-3 mm, most preferably between 1-2 mm.

The prefiltration filter 80 further comprises a mixing unit, arranged inside the prefiltration containing body 81. The mixing unit is provided with one or more scraping elements 86 arranged for spreading the heterogeneous mixture M against the prefiltering wall 84 of the prefiltration containing body 81.

The prefiltration filter 80 further comprises a moving device for moving the scraping elements 86 inside the prefiltration containing body 81 so as to spread the heterogeneous mixture M against the prefiltering wall 84 of the prefiltration containing body 81.

In the version, the moving device comprises a rotatable shaft 87, which is rotatable in the containing body 81 around the longitudinal axis L thereof. The rotatable shaft 87 is moved by means of a motor 90.

The scraping elements 86 are attached to the rotatable shaft 87 so that by rotating the rotatable shaft 87 the scraping elements 86 are made to rotate inside the prefiltration containing body 81 so as to spread the heterogeneous mixture M against the prefiltering wall 84.

Advantageously the scraping elements 86 are so arranged to scrape against the prefiltering wall 84 during the rotation so as to squash the heterogeneous mixture M against the prefiltering wall 84 of the prefiltration containing body 81.

Moreover, the scraping elements 86 are so configured to scrape the surface of the prefiltering wall 84 so as to remove possible deposits from the prefiltering wall 84.

As scraping elements 86 spatulas or brushes could be used, or any other similar spreading elements suitable for spreading the heterogeneous mixture M against the prefiltering wall 84 and to scrape the surface of the prefiltering wall 84.

By rotating the scraping elements 86, the heterogeneous mixture M is spread and squashed against the prefiltering wall 84 and it is thus prefiltered.

The liquid portion of the heterogeneous mixture M and the particles having smaller dimensions than the holes of the prefiltering wall 84 pass through the holes, whilst the particles having bigger dimensions than the holes of the prefiltering wall 84 remain in the prefiltration containing body 81.

A prefiltered residual part PF is collected under the effect of the gravity force in the cone-shaped lower portion 83 of the prefiltration containing body 81 from which it could be discharged by means of a discharge valve 88.

The discharge valve 88 cane be manually or automatically operated.

The time interval between two consecutive openings of the discharge valve 88 is set as a function of the features of the heterogeneous mixture M, i.e., the content and the dimensions of the solid particles.

A prefiltered heterogeneous mixture M0 flows in the gap 85 formed between the prefiltering wall 84 and the external wall 81A of the prefiltration filter 80 and then it is drawn by means of a prefilter outlet conduit 89 to the filtering device 2.

At the outlet of the prefiltration filter 80 it is thus obtained a prefiltered heterogeneous mixture M0 that is fed to the first filtering device 2 as discussed previously for the first version of the apparatus 100 and a prefiltered residual part PF that is collected in the collecting lower portion 83 and then discharged.

The provision of the prefiltration filter 80 is particularly preferred in the cases in which heterogeneous food mixtures having high percentages of solid content therein are treated in the apparatus 101′ and/or when a product P with a particularly high purity is required.

In operation, through the feeding mouth 51, a desired amount of heterogeneous mixture M to be treated is fed into the containing body 50 of the tank 1.

When the desired filling level in the containing body 50 has been reached, the control unit 60 actuates the feeding device to feed the heterogeneous mixture M to be treated to the first filtering device 2, where it is filtered by the first filtering members 20.

In the first filtering device 2, the heterogeneous mixture M from the tank 1 is divided into a first portion of filtered mixture M1 and a residual portion of solid mixture MS1. The first portion of filtered mixture M1 is collected in the collection tank 50, while the residual portion of solid mixture MS1 is conveyed to the tank 1.

The residual portion of solid mixture MS1 has a higher solid content with respect to the starting heterogeneous mixture, usually ranging between 10 and 50%.

Within the containing body 50, the residual portion of solid mixture MS1 is partially mixed with the heterogeneous mixture M that is present within the containing body 50, obtaining an increasingly more concentrated heterogeneous mixture.

By progressively withdrawing the heterogeneous mixture M from the containing body 50 in order to filter it in the first filtering device 2 and progressively feeding the residual portion of solid mixture MS1 in the containing body 50, the solid content of the concentrated heterogeneous mixture M* is increased.

When the solid content of the heterogeneous mixture in the tank 1 becomes higher than a preset threshold value, for example more than 10%, or when the overall level of the mixture within the tank 1 is lower than a preset level, the filtration in the first filtering device 2 is stopped, and the filtration in the second filtering device 3 is started.

The concentration of the heterogeneous mixture in the containing body 50 is measured through special sensors of the apparatus 100, 100′, or inferred from the pressure values detected by special sensors provided for in the first feeding conduit 11 and/or the first filtering device 2 and/or the first connecting conduit 12.

In order to interrupt the filtration in the first filtering device 2 and to start the filtration in the second filtering device 3, the control unit 60 closes the first feeding valve 53 and opens the second feeding valve 54.

Therefore, the feeding of the heterogeneous mixture M to the first filtering device 2 is interrupted, and the feeding of the concentrated heterogeneous mixture M* to the second filtering device 3 starts. The second filtering device 3 receives the concentrated heterogeneous mixture M* from the tank 1 and divides it into a second portion of filtered mixture M2 which is fed to the collection tank 40 and a second portion of concentrated filtered mixture M′.

The concentrated filtered mixture M′ is fed via the recirculation conduit 14 to the containing body 50 in order to be filtered again.

When the concentration of the concentrated filtered mixture M′ is higher than a preset threshold value, for example, a solid concentration higher than 70-80%, the feeding from the second filtering device 3 to the tank 1 is interrupted, and the portion of residual solid mixture MS2 obtained from the second filtering device 3 is transported to a container 41, where it is collected.

The second portion of filtered mixture M2 obtained from the second filtering device 3 is mixed in the collection tank 40 with the first portion of filtered mixture M1 obtained from the first filtering device 2, generating the product P obtained by the filtration apparatus 100, 100′.

Such a product P has very high organoleptic characteristics, and it is usually an excellent quality product.

Indeed, since the product P is obtained by mixing two filtered mixtures, and combines the advantages of both, it has a suitable solid content therein.

The second residual portion of solid mixture MS2 comprises the residual product PR obtained by the filtration apparatus 100, 100′.

Such a residual product is collected into a container, and then discharged.

Such a product has an extremely high concentration of solids, ranging between 80-95%. Therefore, an apparatus is obtained, which is compact and efficient, and that allows obtaining a very high quality product, while reducing material wastes.

In the case in which the apparatus 100′ has also a prefiltration filter 80, the heterogeneous mixture M is fed from the tank 1 to the prefiltration filter 80 for carrying out the prefiltration.

The prefiltered heterogeneous mixture MO obtained at the exit of the prefiltration filter 80 is then fed to the first filtering device 2 to be filtered.

The filtration process is then carried out as disclosed above.

The prefiltration filter 80 could be provided with one or more sensors for sensing the quantity of the prefiltered residual part PF, so as to discharge the prefiltered residual part PF after a certain level thereof is obtained.

As indicated above, the provision of the prefiltration filter 80 increases the efficiency of the apparatus 100′ in treating mixtures having high percentages of solid content.

Moreover, the provision of the prefiltration filter 80 decreases the need to stop the apparatus 100′ for cleaning operations.

With the prefiltration filter 80, it is possible in a very inexpensive and easy way to efficiently remove particles having great dimensions, which would obstruct or damage the membrane filter devices. Although illustrated and described above with reference to certain specific embodiments and versions, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. It is also expressly intended that the steps of the methods of using the various devices disclosed above are not restricted to any particular order.

1. A multi-stage filtration apparatus for heterogeneous food mixtures, comprising:
a tank for holding the heterogeneous mixture to be filtered,
a first filtering device configured to receive the heterogeneous mixture from the tank and to divide it into a first portion of mixture and a residual portion of solid mixture,
a first feeding conduit and a first connecting conduit between the tank and the first filtering device in order to feed the heterogeneous mixture to the first filtering device and the first portion of mixture to the tank, respectively,
a second filtering device configured to receive a concentrated heterogeneous mixture from the tank and to divide it into a second portion of mixture and a second residual portion of solid mixture, and
a second feeding conduit and a second connecting conduit between the tank and the second filtering device in order to feed the concentrated heterogeneous mixture to the second filtering device and the second portion of mixture to the tank, respectively,
wherein the first and the second filtering devices comprise tangential filtration filtering units comprising first filtering members of the membrane type and second filtering members of the tubular type, respectively.

2. The apparatus according to claim 1, wherein the first filtering members are made of ceramic or plastic or polyethersulfone.

3. The apparatus according to claim 1, wherein the first filtering members are of the capillary membrane type, with an inner diameter ranging between 1-2 mm.

4. The apparatus according to claim 1, wherein the first filtering members are composed of membranes having a porosity ranging between 0.1 and 0.8 microns.

5. The apparatus according to claim 1, wherein the second filtering members are of the tubular membrane type, made of steel or a resistant ceramic or polymeric material.

6. The apparatus according to claim 1, wherein the second filtering members have a diameter ranging between 5-20 mm.

7. The apparatus according to claim 1, wherein the second filtering members are composed of membranes having a porosity ranging between 0.1 and 0.8 microns.

8. The apparatus according to claim 1, further comprising at least one feeding device to feed the mixtures into the apparatus.

9. The apparatus according to claim 1, further comprising at least one measurement sensor provided on the tank to measure the level of the heterogeneous mixture in the tank and/or at least one flow rate or pressure sensor in at least one of the conduits to measure the flow rate or pressure of the mixture flowing in the conduits.

10. The apparatus according to claim 1, further comprising a control unit to control and adjust the operation of the filtration apparatus.

11. The apparatus according to claim 10, wherein the control unit is operatively connected to the tank, the first and the second filtering devices, and at least one conduit to adjust the operation of the filtration apparatus.

12. The apparatus according claim 1, further comprising a collection tank configured to hold the second portion of filtered mixture obtained from the second filtering device and the first portion of mixture obtained from the first filtering device.

13. The apparatus according claim 1, further comprising a prefiltration filter device operatively interposed between the first filtering device and the tank and configured to receive the heterogeneous mixture from the tank in order to carry out a prefiltration of the heterogeneous mixture and to obtain a prefiltered heterogeneous mixture that is fed to the first filtering device and a prefiltered residual part that is collected in a collecting portion of the containing body of the prefiltration filter device.

14. A multi-stage filtration apparatus for heterogeneous food mixtures, comprising:
a tank for holding the heterogeneous mixture to be filtered,
a first filtering device configured to receive the heterogeneous mixture from the tank and to divide it into a first portion of mixture and a residual portion of solid mixture,
a first feeding conduit and a first connecting conduit between the tank and the first filtering device in order to feed the heterogeneous mixture to the first filtering device and the first portion of mixture to the tank, respectively,
a second filtering device configured to receive a concentrated heterogeneous mixture from the tank and to divide it into a second portion of mixture and a second residual portion of solid mixture,
a second feeding conduit and a second connecting conduit between the tank and the second filtering device in order to feed the concentrated heterogeneous mixture to the second filtering device and the second portion of mixture to the tank, respectively, and
a prefiltration filter device operatively interposed between the first filtering device and the tank and configured to receive the heterogeneous mixture from the tank in order to carry out a prefiltration of the heterogeneous mixture and to obtain a prefiltered heterogeneous mixture that is fed to the first filtering device and a prefiltered residual part that is collected in a collecting portion of the containing body of the prefiltration filter device,
wherein the first and the second filtering devices comprise tangential filtration filtering units comprising first filtering members of the capillary membrane type and second filtering members of the tubular membrane type, respectively.

15. The apparatus according claim 14, wherein the first filtering members are made of ceramic or plastic or polyethersulfone, include membranes with a porosity ranging between 0.1 and 0.8 microns, and have an inner diameter ranging between 1-2 mm.

16. The apparatus according claim 14, wherein the second filtering members are made of steel or a resistant ceramic or polymeric material, include membranes with a porosity ranging between 0.1 and 0.8 microns, and have a diameter ranging between 5-20 mm.

17. The apparatus according claim 14, further comprising at least one measurement sensor provided on the tank to measure the level of the heterogeneous mixture in the tank and/or at least one flow rate or pressure sensor in at least one of the conduits to measure the flow rate or pressure of the mixture flowing in the conduits.

18. The apparatus according claim 14, further comprising a control unit to control and adjust the operation of the filtration apparatus.

19. The apparatus according claim 14, further comprising a collection tank configured to hold the second portion of filtered mixture obtained from the second filtering device and the first portion of mixture obtained from the first filtering device.

20. A multi-stage filtration apparatus for heterogeneous food mixtures, comprising:
a tank for holding the heterogeneous mixture to be filtered,
a first filtering device configured to receive the heterogeneous mixture from the tank and to divide it into a first portion of mixture and a residual portion of solid mixture,
a first feeding conduit and a first connecting conduit between the tank and the first filtering device in order to feed the heterogeneous mixture to the first filtering device and the first portion of mixture to the tank, respectively,
a second filtering device configured to receive a concentrated heterogeneous mixture from the tank and to divide it into a second portion of mixture and a second residual portion of solid mixture,
a second feeding conduit and a second connecting conduit between the tank and the second filtering device in order to feed the concentrated heterogeneous mixture to the second filtering device and the second portion of mixture to the tank, respectively,
at least one measurement sensor provided on the tank to measure the level of the heterogeneous mixture in the tank and/or at least one flow rate or pressure sensor in at least one of the conduits to measure the flow rate or pressure of the mixture flowing in the conduits,
a control unit to control and adjust the operation of the filtration apparatus, and
a prefiltration filter device operatively interposed between the first filtering device and the tank and configured to receive the heterogeneous mixture from the tank in order to carry out a prefiltration of the heterogeneous mixture and to obtain a prefiltered heterogeneous mixture that is fed to the first filtering device and a prefiltered residual part that is collected in a collecting portion of the containing body of the prefiltration filter device,
wherein the first and the second filtering devices comprise tangential filtration filtering units comprising first filtering members of the capillary membrane type and second filtering members of the tubular membrane type, respectively.
